(19) United States
(12) Patent Application Publication
(10) Pub. No.: US 2025/0139644 A1
(43) Pub. Date: May 1, 2025

(54) Method and System for Electronic Life Cycle Assessment (LCA) for Supply Chain Management Leveraging Templates

(71) Applicant: P6Technologies, Inc., Spicewood, TX (US)

(72) Inventors: Joseph G. Berti, Spicewood, TX (US); Kira Alexandra Mulshine, Beacon, NY (US)

(21) Appl. No.: 18/931,316

(22) Filed: Oct. 30, 2024

Related U.S. Application Data
(60) Provisional application No. 63/595,040, filed on Nov. 1, 2023.

(51) Int. Cl. G06Q 30/018

(52) U.S. Cl. CPC G06Q 30/018

(57) ABSTRACT

A present invention embodiment provides a Life Cycle Assessment (LCA) system that addresses the limitations of existing systems. The system offers an intuitive, user-friendly interface that simplifies the complexity of LCA methodologies, making environmental impact assessment accessible to a broader audience. It incorporates advanced algorithms and real-time data integration, ensuring accurate and up-to-date assessments. Additionally, the system is designed with a modular architecture and is highly configurable, allowing seamless integration with various industries and accommodating diverse items including products, services, and processes.

### CROSS-REFERENCE TO RELATED APPLICATIONS

This application claims priority to U.S. Provisional Patent Application Ser. No. 63/595,040, entitled “Method and System for Electronic Life Cycle Assessment (LCA) for Supply Chain Management Leveraging Templates” and filed on Nov. 1, 2023, the disclosure of which is incorporated herein by reference in its entirety.

### FIELD OF THE INVENTION

The present invention embodiments relate to the field of environmental sustainability and supply chain management. More specifically, a present invention embodiment pertains to an electronic system for conducting life cycle assessments and sharing the results online among suppliers and customers in a supply chain.

The present invention embodiments further relate to the field of environmental impact assessment and, more specifically, to a life cycle assessment (LCA) system used for evaluating the environmental footprint and impact analysis of products or processes. This system aids in quantifying the environmental impact of a product throughout its entire life cycle, from raw material extraction to disposal, providing valuable insights for sustainable decision-making.

### BACKGROUND

Traditional Life Cycle Assessment (LCA) software tools have been pivotal in assisting businesses and organizations in analyzing the environmental impacts associated with their products or services. These tools typically involve complex methodologies, including data collection, impact assessment, and interpretation, making them intricate for users without a deep understanding of environmental science.

Existing software tools suffer from limitations, including:
Complexity: Conventional LCA software tools are intricate, requiring specialized knowledge in both environmental science and software operation, making them inaccessible to many businesses and organizations;
Limited Scope: Existing software tools focus on specific industries or have a narrow scope, limiting their applicability to a wide array of products and processes;
Data Accuracy: The accuracy of LCA results heavily relies on the quality of input data. Existing software tools sometimes lack access to updated or precise data sources, leading to less accurate environmental impact assessments;
User Interface: User interfaces of existing software tools can be unintuitive and challenging for non-experts, hampering the efficient use of these tools for decision-making. Life cycle assessments have to be completed from scratch for products where the user needs to define all inputs, outputs, emissions factors and other information needed to perform a life cycle assessment;
Incomplete: Existing systems do not produce a complete Life Cycle Assessment (LCA) that is ready for submission. They produce the data needed to produce a life cycle assessment report that has to then be produced after the software tool provides information on the environmental impact of a product or service;
Use of secondary source data: Existing software tools require the use of databases from secondary sources for emissions factors. These emissions factors are not directly tied to the source facility that produces a product or provides a service and, therefore, are not completely accurate;
Inability for users to develop models: Existing software tools have models for calculating carbon footprint and impact analysis using models that are produced by the software provider. Adding new models requires modification of the software which the software vendor can only do themselves;
Electronic data exchange: Existing software tools do not allow a company to share a life cycle assessment electronically across the supply chain in a manner that allows the recipient of that information to receive updates that are made to a products life cycle on a network-based solution. This results in life cycle assessments being static and not communicated in a real-time manner. The existing systems utilize complex database exports, so the data is not easily consumed or utilized across the supply chain; and
Lack of Comprehensive Approval Management Workflow: Existing systems do not provide a comprehensive approval management workflow and, therefore, do not encourage review/audit of information from other parties before publishing or submitting the information. Therefore, quality may be reduced.

### BRIEF SUMMARY OF EMBODIMENTS OF THE INVENTION

The present invention embodiments provide a Life Cycle Assessment (LCA) system that addresses the limitations of existing systems. The LCA system offers an intuitive, user-friendly interface that simplifies the complexity of LCA methodologies, making environmental impact assessment accessible to a broader audience. It incorporates advanced algorithms and real-time data integration, ensuring accurate and up-to-date assessments. Additionally, the LCA system is designed with a modular architecture and is highly configurable, allowing seamless integration with various industries and accommodating diverse items including products, services, and processes.

Present invention embodiments provide several advantages, including:
User-Friendly Interface: The LCA system provides an intuitive interface, enabling users with varying levels of expertise to perform comprehensive LCA effortlessly. Leveraging a highly configurable user interface and templates allows users to build a life cycle assessment that pre-defines the inputs and outputs, the emissions factors, models, and overall information needed to create an LCA for the specific products or services, thereby significantly reducing the time it takes to develop a life cycle assessment;
Scalability and Flexibility: The modular design leveraging configurable LCA templates allows the LCA system to adapt to different industries and accommodate a wide range of products and processes, making it versatile and scalable;
Primary source data: The LCA system provides the ability to reach out to a supplier to ask them to perform a complete LCA using a template, allowing the supplier to complete the LCA faster and eliminating the need for secondary databases and resulting in a more accurate assessment of the life cycle of a product or service;
Real-time Data Updates: The LCA system incorporates real-time data updates to LCAs where all participants across the supply chain are notified of changes or updates, ensuring that the environmental impact assessments are based on the most current and accurate data available;
Decision Support: The LCA system offers valuable insights and suggestions for sustainable practices, empowering businesses to make informed decisions for reducing their environmental footprint for products leveraging data from LCAs;
Cloud-Based Collaboration: The LCA system preferably operates on a cloud-based platform, facilitating collaborative efforts among team members who produce or provide materials or energy into a product, thereby affecting the LCA, regardless of their geographical locations, enhancing efficiency and productivity;
Real-Time: The LCA system updates Life Cycle Assessments (LCAs) in real-time as data or life cycle assessments are updated, allowing for all participants in the supply chain to immediately benefit from improvements made to product processes, energy, or inputs; and
Forecasts: The LCA system provides both historical actuals and forecasted carbon footprint information and emissions. This moves a company from a static view of a life cycle assessment, often updated every 1-2 years, to a daily, weekly, or monthly update on how their facilities are trending.

Accordingly, the present invention embodiments provide a significant advancement in the field, offering a user-friendly, accurate, and versatile technique for assessing the environmental impact of products and processes. The features and functionalities of present invention embodiments revolutionize the way to approach sustainability, aligning environmental responsibility with economic success.

### BRIEF DESCRIPTION OF THE DRAWINGS

The following diagrams describe embodiments for creating an electronic life cycle assessment (LCA) to perform Life Cycle Analysis (e.g., for a product produced by a manufacturing facility, etc.).

Generally, like reference numerals in the various figures are utilized to designate like components.

FIG. 1 is a diagrammatic illustration of a system architecture including system components, such as the user interface, model builder and engine, process builder, workflow engine, application programming interface, database, and corresponding software according to an embodiment of the present invention.

FIGS. 2A-2B illustrate an electronic Life Cycle Assessment (LCA) process flow diagram showing the operations involved in creating and sharing an electronic Life Cycle Assessment according to an embodiment of the present invention.

FIG. 3 is a schematic illustration of an example user interface representing how the user interface looks for the guided workflow to create an electronic Life Cycle Assessment (LCA) across the supply chain driven by a template (e.g., built by a template builder) using an LCA process builder to generate a system boundary for a product, and leveraging an LCA model (e.g., built by a model builder) according to an embodiment of the present invention.

FIG. 4A illustrates a process flow diagram showing the operations involved in managing templates according to an embodiment of the present invention.

FIGS. 4B-4C are schematic illustrations of example user interfaces for managing templates according to an embodiment of the present invention.

FIG. 5A illustrates a process flow diagram showing the operations involved in managing models according to an embodiment of the present invention.

FIGS. 5B-5C are schematic illustrations of example user interfaces for managing models according to an embodiment of the present invention.

FIG. 6 is a diagrammatic illustration of data flow and security showing how data flows amongst participants of the system and for sending data to and from the system to company systems according to an embodiment of the present invention.

FIG. 7 is a diagrammatic illustration of sharing the LCA across the supply chain and showing how the system seamlessly interacts with suppliers and customers across the supply chain in real-time, along with updates being made to product life cycle assessments according to an embodiment of the present invention.

FIGS. 8A-8I are an illustration of an example LCA report according to an embodiment of the present invention.

FIG. 9 is a block diagram of an example computing device according to an embodiment of the present invention.

### DETAILED DESCRIPTION OF EXAMPLE EMBODIMENTS

The electronic life cycle assessment (LCA) system of embodiments described herein is designed to facilitate the measurement, analysis, and sharing of environmental impacts associated with items, including products, services, and processes, across the entire supply chain. The LCA system employs a user-friendly interface accessible via the internet or other network, allowing users to input relevant data and generate comprehensive life cycle assessments (LCAs). Templates are utilized to define the workflows, inputs, outputs, energy, elements, and emissions factors associated with the production of a particular type of product (e.g., service, process, material, goods, etc.), thereby streamlining the creation of a Life Cycle Assessment (LCA).

Features of embodiments of the present invention include:
Online Interface: A web-based platform accessible to authorized users, allowing them to conduct life cycle assessments using standardized methodologies and form online templates;
Data Input: The ability to input various data points, including raw material sourcing, manufacturing processes, transportation, product use, end-of-life disposal methods, recycling or reuse processes, along with the ability to have suppliers involved in providing data to produce an LCA;
Calculation Engine: An advanced calculation engine built using a modeling tool inside the software of the LCA system that processes the input data to determine the environmental impacts, such as carbon footprint, water usage, the human impact and energy consumption related to processing, producing, and transporting a product;
Process builder: An online tool that enables a system boundary to be electronically designed and shared;
Visualization Tools: Graphical representations and interactive charts that help users understand and interpret the life cycle assessment results;
Sharing Capabilities: The LCA system enables the electronic sharing of life cycle assessment reports among suppliers and customers within the supply chain. Reports can be sent securely via email or accessed through a secure online portal; and
Real-time Updates: The ability to update assessments in real-time as new data becomes available, ensuring that the environmental impact data is accurate and up-to-date.

Present invention embodiments provide several advantages, including:
Streamlined and efficient life cycle assessments;
Enhanced collaboration and transparency across supply chains for sharing Life Cycle Assessment information;
Reduction in paper usage and environmental impact associated with traditional printed life reports related to life cycle assessments;
Real-time access to updated product life cycle impact data; and
Accelerated insights into product carbon impacts, enabling quicker emissions reduction decisions and progress tracking.

In one example, the electronic system of a present invention embodiment provides a unique template builder for a Life Cycle Assessment (LCA), thereby accelerating a user's ability to complete an LCA and determine the carbon intensity of a product.

In an example, the electronic system templates provide a high degree of configurability for the workflow, inputs, outputs, processes, elements, energy, and emissions factors for a specific product for which the template produces an LCA.

In an example, the electronic system provides an electronic library of emissions factors that is searchable and indexed using elastic search.

In an example, the electronic system allows the user to build a custom model and then use it inside of an LCA template. The model is used to calculate the carbon footprint of a product and other impacts, such as human impacts, ecological impacts, and/or land use impacts.

In an example, the electronic system allows a user to request a supplier to perform an LCA using a template, which then ensures the scope and boundary of the life cycle assessment meets the criteria of the company requesting the LCA.

In an example, the electronic system allows a user to request data from a supplier for the purpose of completing a portion of a template for an LCA.

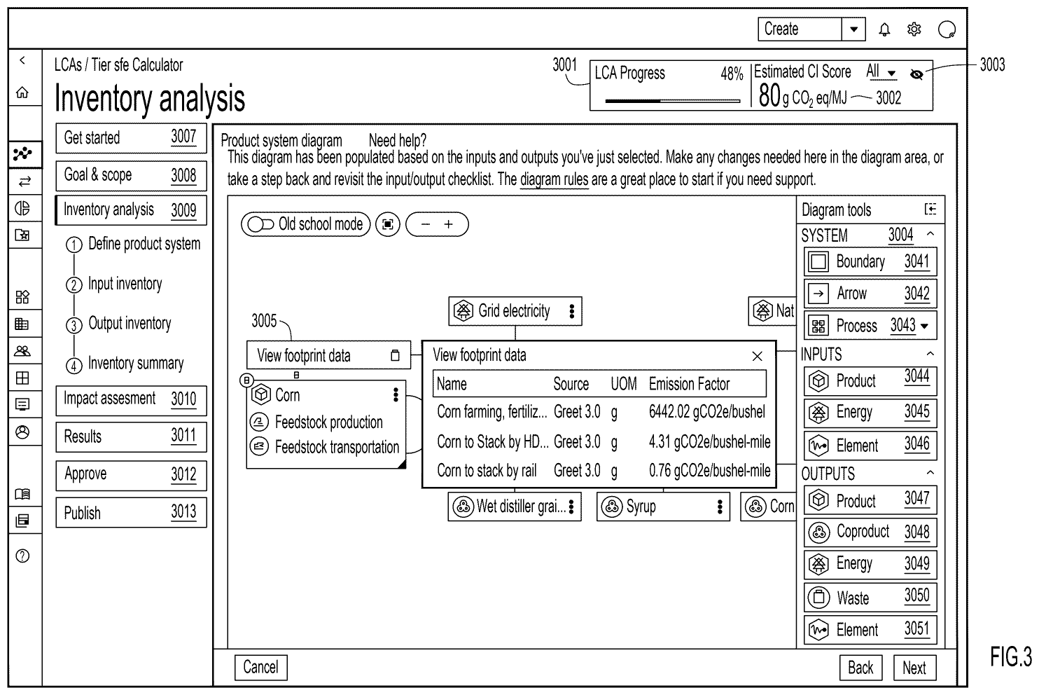

In an example, the electronic system allows a user to build an electronic system boundary diagram for an LCA using a drag and drop interface including configurable inputs, outputs, elements, and/or energy (FIG. 3).

In an example, the electronic system allows a user to, within an electronic system boundary diagram, search an LCA library of emissions factor databases utilizing an elastic search assigning those emissions factors to inputs, outputs, processes, elements, and/or energy (FIG. 3).

In an example, the electronic system displays the progress of LCA completion associated with the overall progress being made on completing an LCA utilizing an LCA template (FIG. 3).

In an example, the electronic system dynamically displays the carbon intensity for the entire output of a product based on data being entered into an LCA template (FIG. 3).

In an example, the electronic system dynamically displays the carbon intensity for one of the outputs, chosen by a user via a drop down list, of a product based on data being entered into an LCA template (FIG. 3).

In an example, the electronic system can dynamically generate the system boundary diagram from inputs selected during the template workflow.

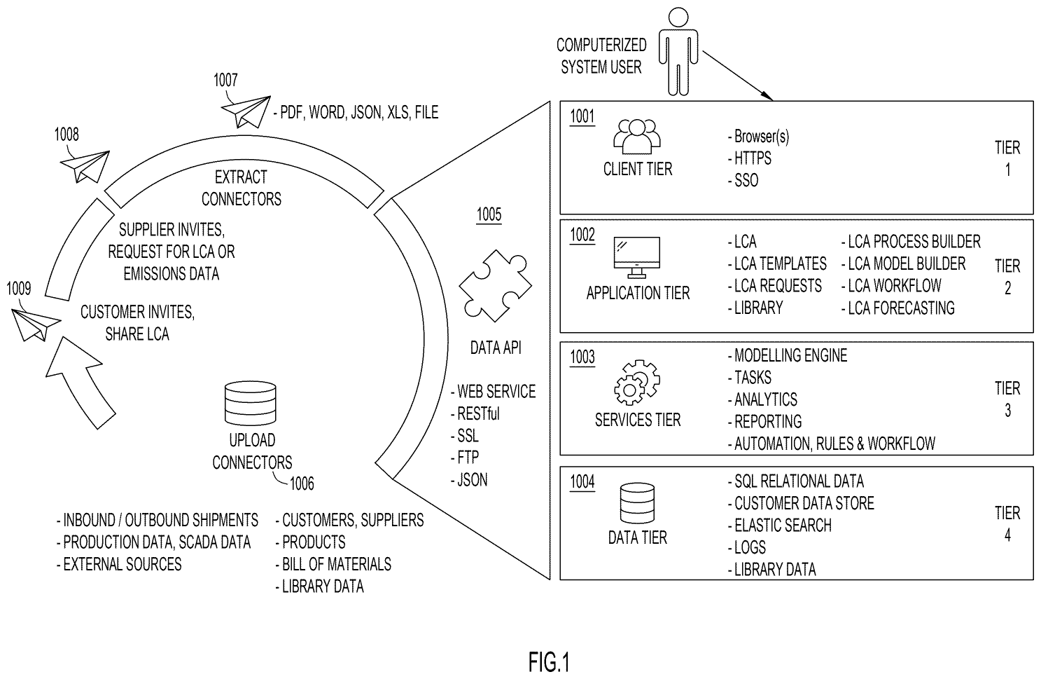

An example system architecture according to an embodiment of the present invention is illustrated in FIG. 1. By way of example, the electronic life cycle assessment (LCA) system is accessed via a browser by a system user 1001. The electronic system includes a software application that provides the functionality via a computerized user interface 1002. The software also includes computerized services 1003 that perform calculations, move data, and automate the completion of work. This includes a modelling engine to calculate carbon intensity and run impact analysis algorithms, an analytics engine that summarizes data for complex reporting, a task engine that is used to complete specific tasks, an automation engine that is used to automate work, and a rules and workflow engine that is used to perform complex rules and manage workflow within the application.

The electronic life cycle assessment system also includes a data tier 1004 that is used for storing data in relational databases, column stores, elastic search, and graph databases. The data tier also includes customer data stores where data can be uploaded from a customer system into the electronic life cycle assessment system.

The electronic life cycle assessment system also includes application programming interfaces 1005 to allow data to be imported and exported from the system using a web service (e.g., RESTFUL service, SSL, FTP, JSON, etc.).

The electronic system includes connectors 1006 to external software tools to ease the import and export of data from the electronic life cycle assessment system. Data such as, but not limited to, shipments, production data (inventory), data from SCADA systems (such as temperature or moisture readings), customer data, supplier data, bill of material data, and library data which includes emissions factor data from open source and third-party licensed data. The electronic system may also include extract connectors 1007 to produce PDF, Word, JSON, XML and File exports to external users and computerized systems.

The electronic life cycle assessment system can electronically invite suppliers 1008 to perform life cycle assessments or provide emissions factor data, and can electronically invite customers 1009 to share electronic life cycle assessments with them.

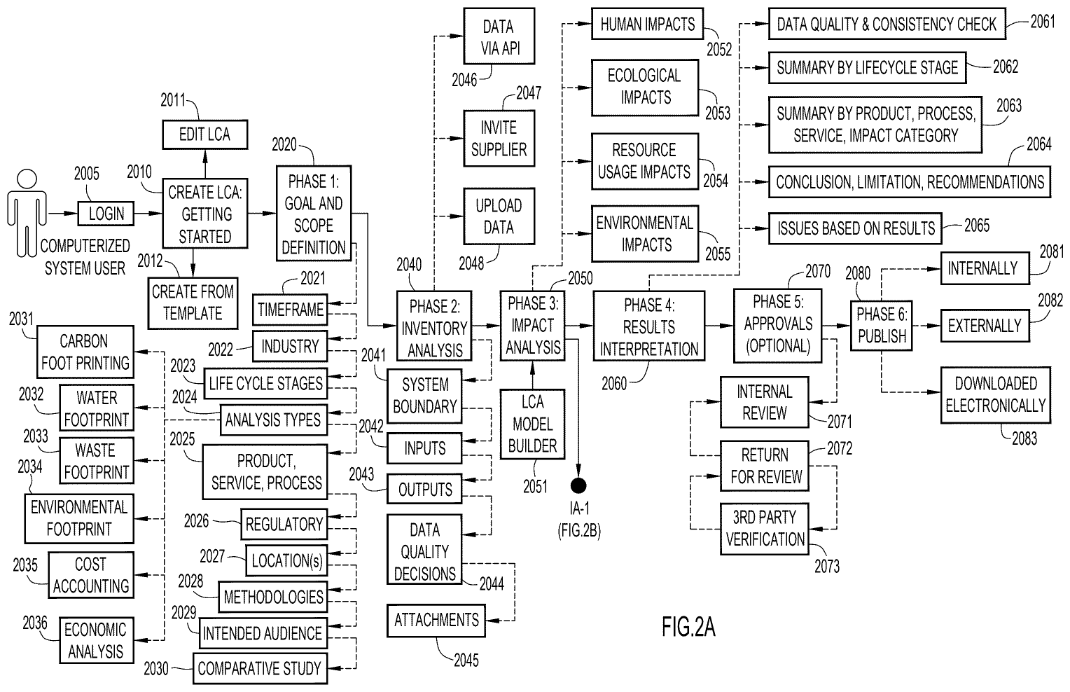

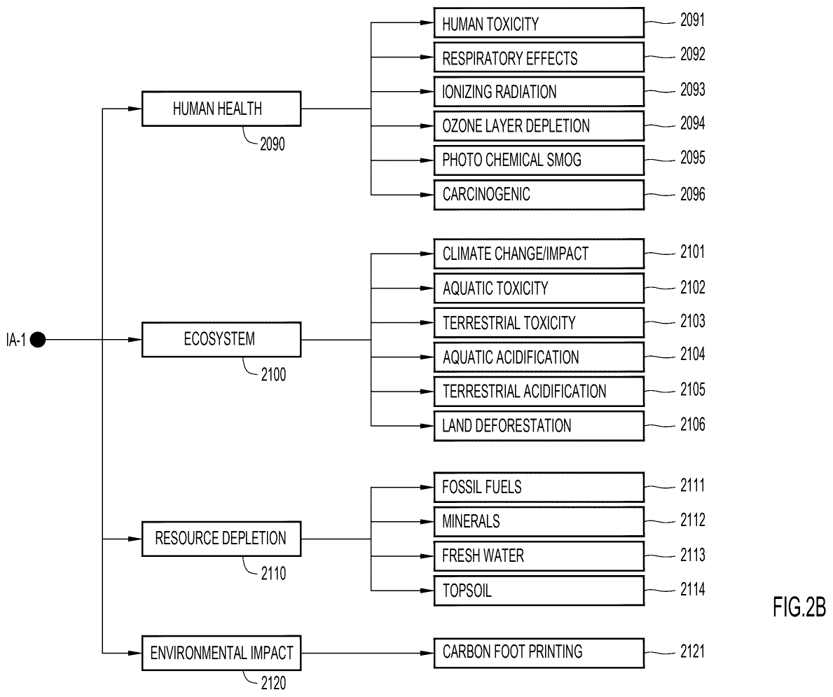

An electronic Life Cycle Assessment (LCA) process flow diagram according to an embodiment of the present invention is illustrated in FIGS. 2A-2B. By way of example, a system user logs into an electronic system running on a cloud computing environment at operation 2005 and may create at operation 2010, edit at operation 2011, or create from a template at operation 2012, an electronic life cycle assessment (LCA).

When creating an LCA, the user is guided through a workflow which is defined in a template (at operation 2012) that in general follows the operations typically included to create an LCA (or LCA report), including Goal and Scope Definition at operation 2020, Inventory Analysis at operation 2040, Impact analysis at operation 2050, Results Interpretation at operation 2060, Approvals at operation 2070, and Publishing at operation 2080.

Within an electronic LCA created from a template, the Goal and Scope Definition at operation 2020 includes, a timeframe 2021, an industry 2022, life cycle stages 2023 (e.g., raw material, process material, manufacture product, transportation, consume product, end of life, recycle, etc.), analysis types 2024 (e.g., carbon footprint 2031, water footprint 2032, waste footprint 2033, environmental footprint 2034, cost accounting 2035, economic analysis 2036), whether or not the LCA is for a product, service, or process 2025, applicable regulatory agencies 2026, locations or facilities 2027 for where the product is manufactured and that is in scope for the LCA, LCA methodologies 2028 that apply, the intended audience for the LCA 2029, and whether or not the LCA is for a comparative study 2030. A comparative study may be a study where the LCA of two separate products are compared to determine which approach would produce less impact to the environment.

Within an electronic LCA created from a template, the inventory 2042 associated with the inputs into the product, and outputs 2043 from the processes can be gathered and an electronic system boundary diagram can be created at operation 2041 (FIG. 3). The electronic system determines data quality decisions 2044 and allows attachments 2045 to the LCA to store documentation to back up the data entered into the electronic system. The Inventory Analysis at operation 2040 may receive data via an API at operation 2046, invite suppliers at operation 2047, and upload data at operation 2048.

The electronic life cycle assessment (LCA) system has a screen or user interface that walks the user through the entire workflow of creating an LCA as illustrated, by way of example, in FIG. 3. This may include operations for Getting Started 3007, Goal and Scope 3008, Inventory Analysis 3009, Impact Assessment 3010, Results 3011, Approve 3012, and Publish 3013.

The electronic LCA may have within the workflow of creating or editing an LCA a progress indicator 3001 to let the user know what percent of the template has been completed.

The electronic LCA may have within the workflow of creating or editing an LCA an estimated carbon intensity score 3002 for the product, process, or service being represented. The user may also have the ability to see the carbon intensity 3003 for all outputs, or one of the outputs.

The electronic LCA (e.g., in a process builder used to create an electronic system boundary diagram) may have a drag and drop user interface 3004 to allow the user to add system boundaries 3041, arrows 3042, processes 3043, inputs including products (or service or process) 3044, energy 3045, elements 3046, and outputs including products (or service or process) 3047, coproducts 3048, energy 3049, waste 3050, and elements 3051.

The electronic LCA (e.g., in the process builder used to create an electronic system boundary diagram) may have the ability to assign emissions factors 3005 to an input, process, or output. The emissions factors can be keyed in or can be obtained from a library that is indexed with elastic search so that the user can search across all library data quickly.

The electronic LCA (e.g., in the process builder used to create an electronic system boundary diagram) may have the ability to leverage emissions factors from a life cycle assessment that was requested of a supplier using the supply chain request capability within the electronic system.

Referring back to FIG. 2A, the electronic LCA within the workflow driven by a template, may have the ability to perform Impact Analysis on a product (IA-1 of FIG. 2B) using various methods. The electronic LCA system also allows a system user to choose a model that is pre-built into the system or one that is built. The model may be built using a model builder 2051, which is used to build a custom model to perform impact analysis.

The electronic LCA impact analysis may perform Human Impact Analysis at operation 2052, Ecological Impact at operation 2053, Resource Impact at operation 2054, and/or Environmental Impact at operation 2055.

The electronic LCA provides the ability to perform results interpretation using a graphical user interface, that may or may not include drag and drop capabilities, at operation 2060. This includes operations, such as automation data quality and consistency checks 2061, summary by life cycle stage 2062, summary by product, process, or service and summary by input type, supplier, energy input or output, or impact category 2063. It may also include conclusions, limitations and recommendations in the results analysis at operation 2064). Issues based upon the results of the LCA may also be included in results analysis at operation 2065.

The electronic LCA may have electronic approvals at operation 2070 that are user defined in a template based upon type of approver, and then specific users when completing the LCA. The types of approvers include internal reviewers 2071, external reviewers 2072, and third-party verifiers 2073.

The electronic LCA provides the system user the ability to electronically publish an LCA at operation 2080. This includes publishing internally at operation 2081 or externally at operation 2082, or allow the system user to download the LCA electronically to a spreadsheet, PDF document, or word document at operation 2083.

Referring to FIG. 2B, by way of example, the electronic LCA template allows a user to define the type of impact analysis the LCA utilizes. This includes Human Health 2090, Ecosystem 2100, Resource Depletion 2110, and/or Environmental Impact 2120.

The electronic LCA Human Health impact analysis 2090 can include human toxicity 2091, respiratory effects 2092, ionizing radiation 2093, ozone layer depletion 2094, photo chemical smog 2095, and/or carcinogenic 2096.

The electronic LCA Ecosystem impact analysis 2100 can include climate change/impact 2101, aquatic toxicity 2102, terrestrial toxicity 2103, aquatic acidification 2104, terrestrial acidification 2105, and/or land deforestation 2106.

The electronic LCA Resource Depletion impact analysis 2110 can include fossil fuels 2111, minerals 2112, freshwater 2113, and/or topsoil 2114.

The electronic LCA Environmental Impact analysis 2120 can include carbon footprinting for a product, service, or process 2121.

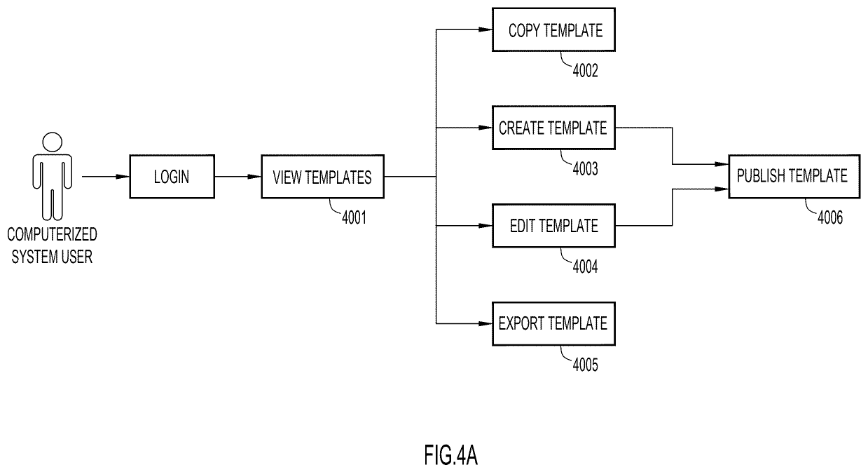

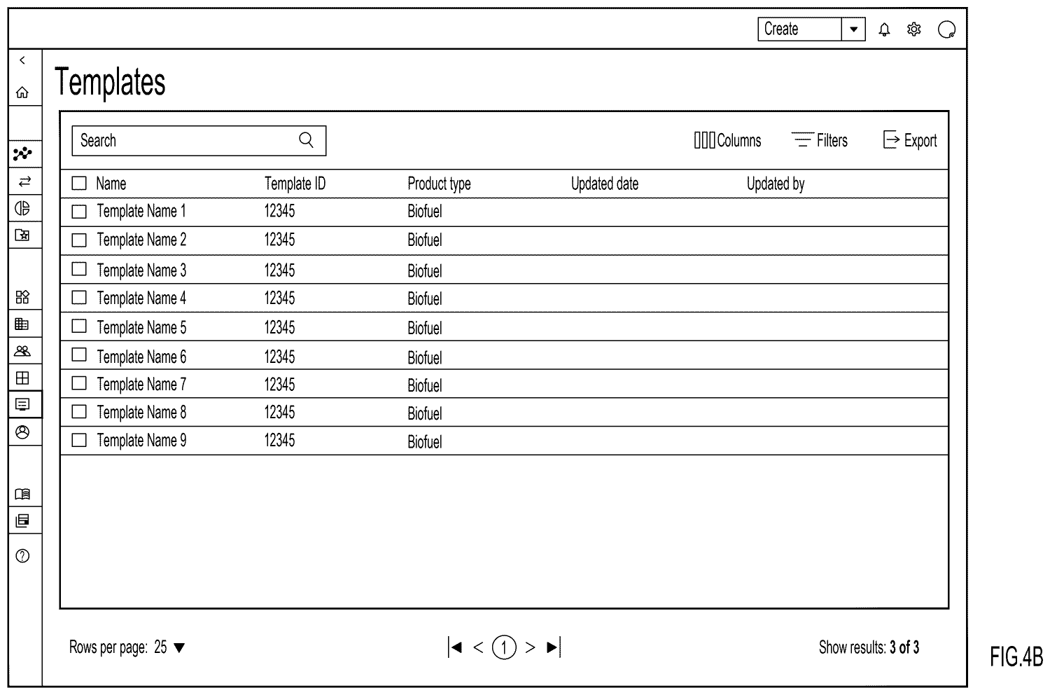

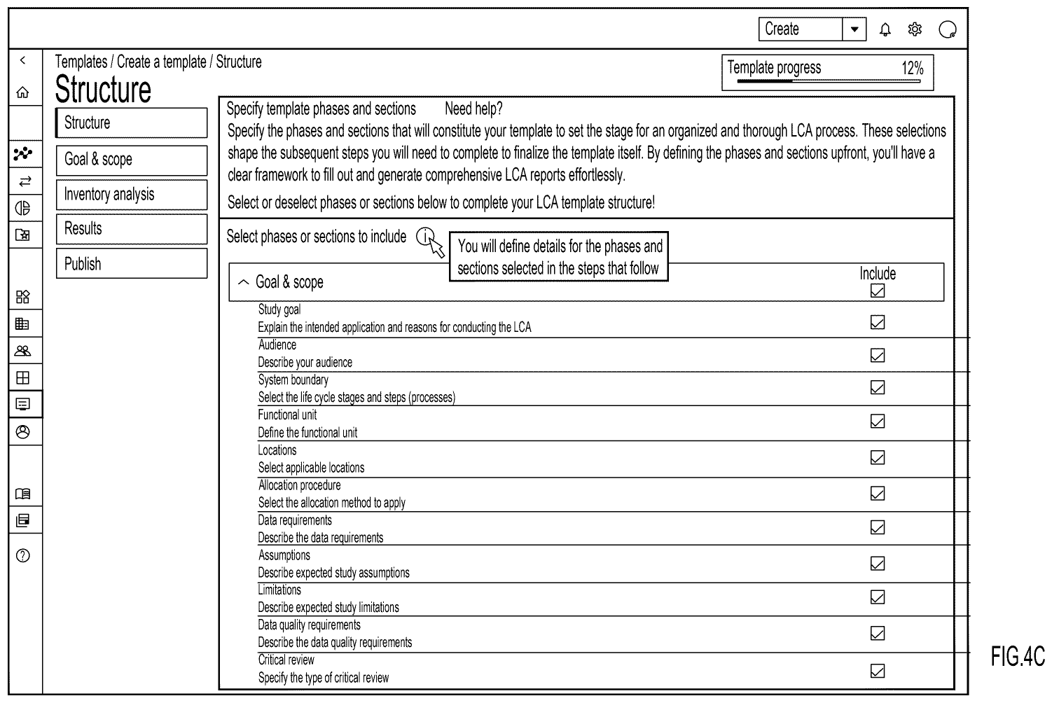

Management of templates according to an embodiment of the present invention is illustrated in FIGS. 4A-4C. By way of example, the electronic life cycle assessment (LCA) system can enable a user to create a template at operation 4003 that makes the process of creating an electronic life cycle assessment much faster as it defines the workflow, inputs, outputs, energy, impact analysis, model(s), results, and in general, the sections that are relevant to creating a life cycle assessment for a particular product. A template can also include custom fields and content, making them highly configurable.

The user can define within a template which sections of a life cycle assessment are required, optional, or should not even be included to complete an LCA using the defined template (as shown in FIG. 4C). Further, a user can view templates at operation 4001 (as shown in FIG. 4B).

A user can copy a template at operation 4002, edit a template at operation 4004, export a template at operation 4005, and/or publish a template at operation 4006 making it available to other users whom they have provided access to their data.

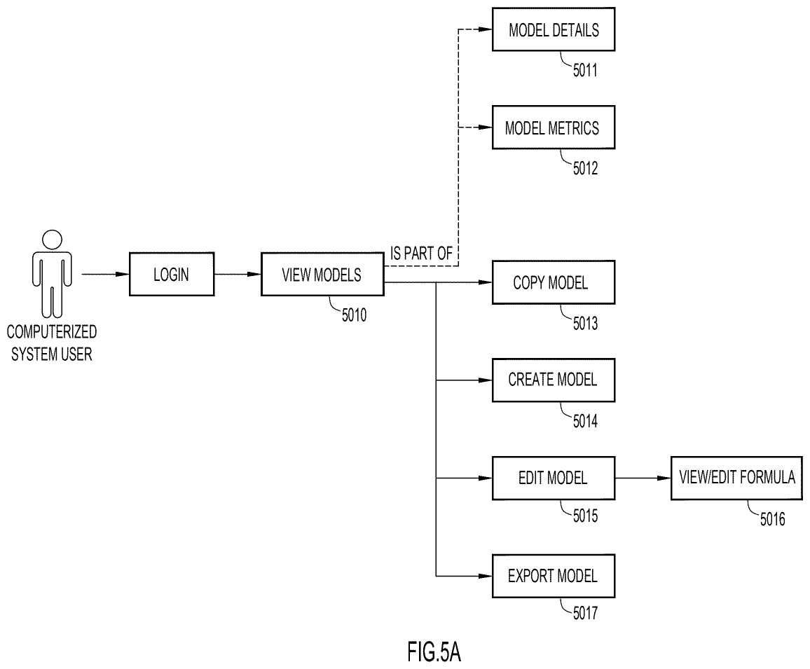

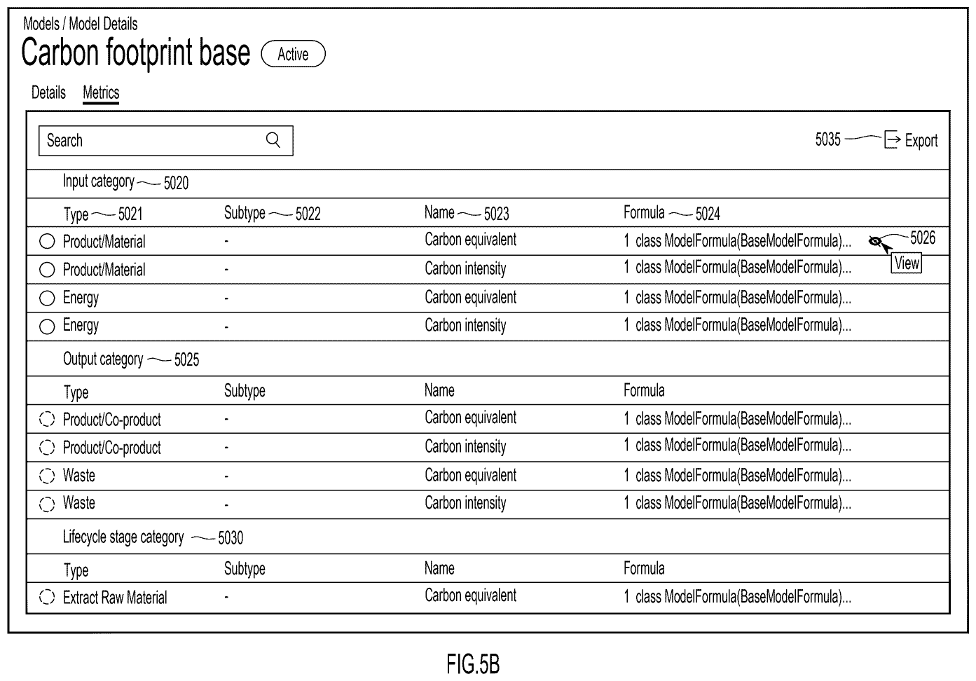

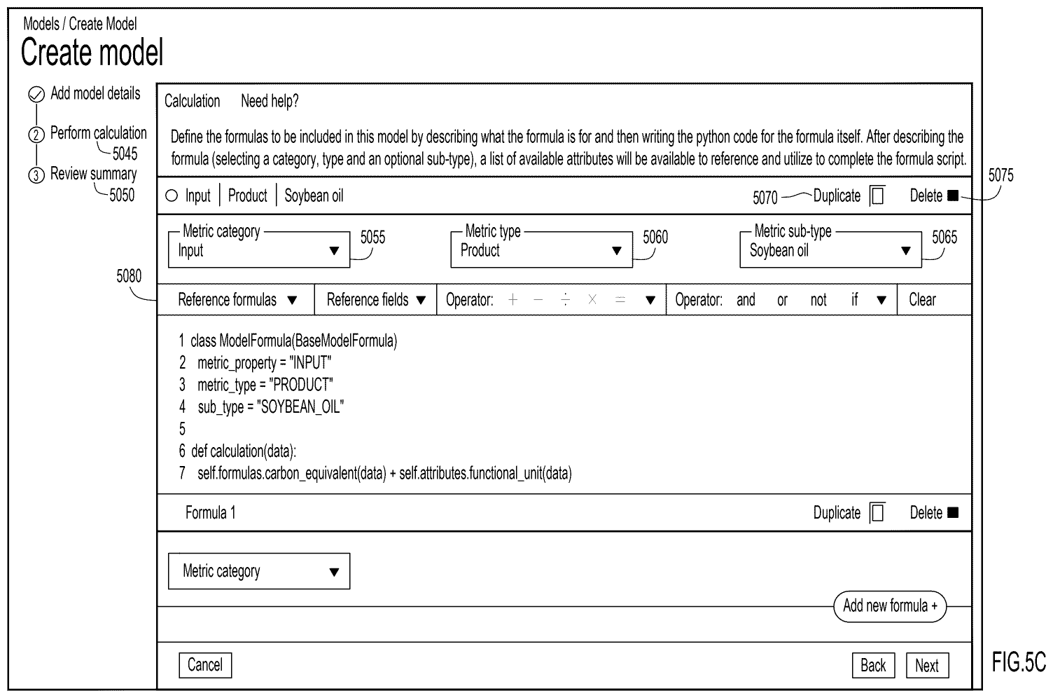

Management of models according to an embodiment of the present invention is illustrated in FIGS. 5A-5C. By way of example, a user can view models at operation 5010 (FIG. 5A) in the electronic system that a user has created and models that have been provided with the electronic system. The electronic system provides generalized models, such as carbon footprinting. To allow users to produce life cycle assessments quicker, generalized models may be provided within the electronic system, such as Argonne Greet 3.0.

Other types of impact analysis in addition to carbon footprinting that require models include Human Health impact analysis 2090, Ecosystem impact analysis 2100, and Resource Depletion impact analysis 2110 (as shown in FIG. 2B).

Human health impact analysis 2090 includes models and results analysis for human toxicity 2091, respiratory effects 2092, ionizing radiation 2093, ozone layer depletion 2094, photo chemical smog 2095, and/or carcinogenic 2096 (as shown in FIG. 2B).

Ecosystem impact analysis 2100 includes models and results analysis for climate change impact 2101, aquatic toxicity 2102, terrestrial toxicity 2103, aquatic acidification 2104, terrestrial acidification 2105, and/or land deforestation 2106 (as shown in FIG. 2B).

Resource depletion impact analysis 2110 includes models and results analysis for fossil fuels 2111, minerals 2112, freshwater 2113, and topsoil 2114 (as shown in FIG. 2B).

The user can, after viewing a listing of models available in the electronic system, drill down to view or edit model details at operations 5011, 5012 (FIG. 5A). This includes viewing the analysis type (as defined in FIG. 2B), the impact category, a description of the model, tags which are assigned and used to search models, and who created the model.

A user can copy and then edit a model provided by the electronic system or a custom model built by the user at operations 5013, 5015.

In the electronic system, the user can export models at operation 5017 (FIG. 5A), 5035 (FIG. 5B) making it easier to transport them between development, test, and production instances of the software. In the electronic system, a user can also view or edit formulas at operations 5024, 5026, making the modelling solution highly configurable and extensible, allowing more types of analysis to be performed.

A user can create a new model in the electronic system at operation 5014 (FIG. 5A) and then after saving it, edit that model or any other model provided by the electronic system at operation 5015. The model in the electronic system contains formulas, which can also be viewed, created or edited at operation 5016.

The user can also view and edit the metrics associated with a model (as shown in FIG. 5B) that includes Input Categories 5020, Output Categories 5025, and Lifecycle Stage Categories 5030. In the electronic system, the Input Category types 5021 include, but are not limited to, product/material inputs and energy inputs. Input, output, and lifecycle stage categories 5020, 5025, 5030 include types 5021, sub-types 5022, name 5023, and the formula 5024 used to calculate the values for the associated impact category.

When creating a model at operation 5045 (FIG. 5C), the user can define the calculations that happen on inputs, processes, outputs, and/or energy. Once the model is created, the user can view a summary of the model to ensure it is correct at operation 5050. When creating a model, calculations and formulas are associated with metric categories 5055, metric types 5060, and metric sub-types 5065. Formulas can be duplicated at operation 5070 and deleted at operation 5075. To make building models easier, reference formulas 5080 are leveraged that are typical for creating life cycle assessments, which then leverage reference fields, operators (e.g., +, −, >, <, =, !=, etc.), etc.

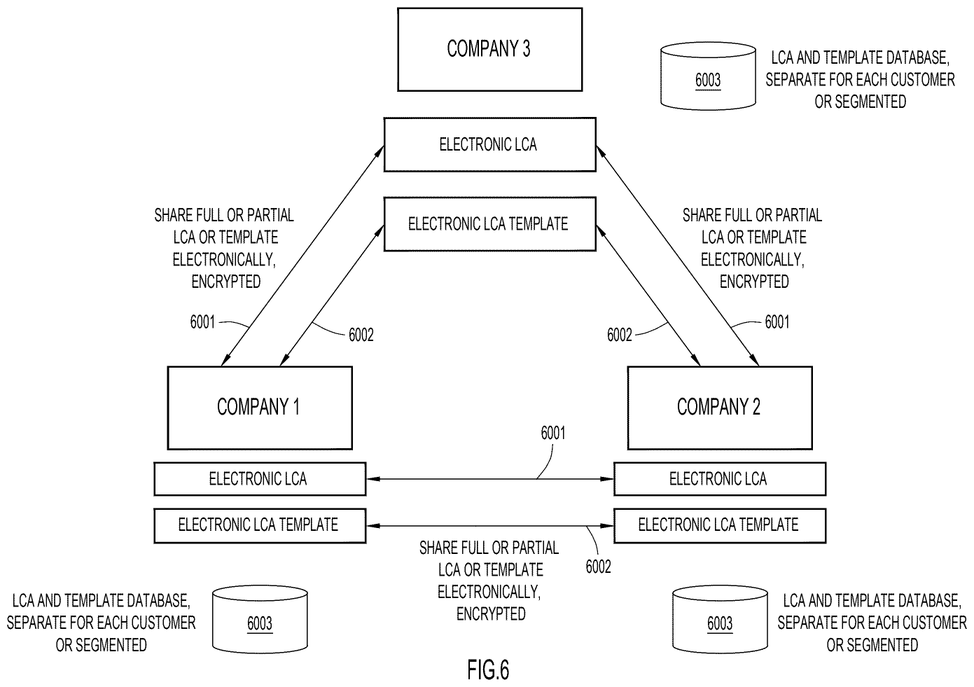

Referring to FIG. 6, the electronic life cycle assessment system may allow companies to share a full or partial LCA electronically or encrypted between their company and another, who can be a supplier or a customer at flow 6001.

The electronic life cycle assessment system allows companies to share a full or partial LCA electronically based on a template between their company and another company, who can be a supplier or a customer at flow 6002.

The electronic life cycle assessment system stores data for each customer in a separate database 6003 or in a database that is segmented in a way that prevents any customer from getting access to another customers data without permission.

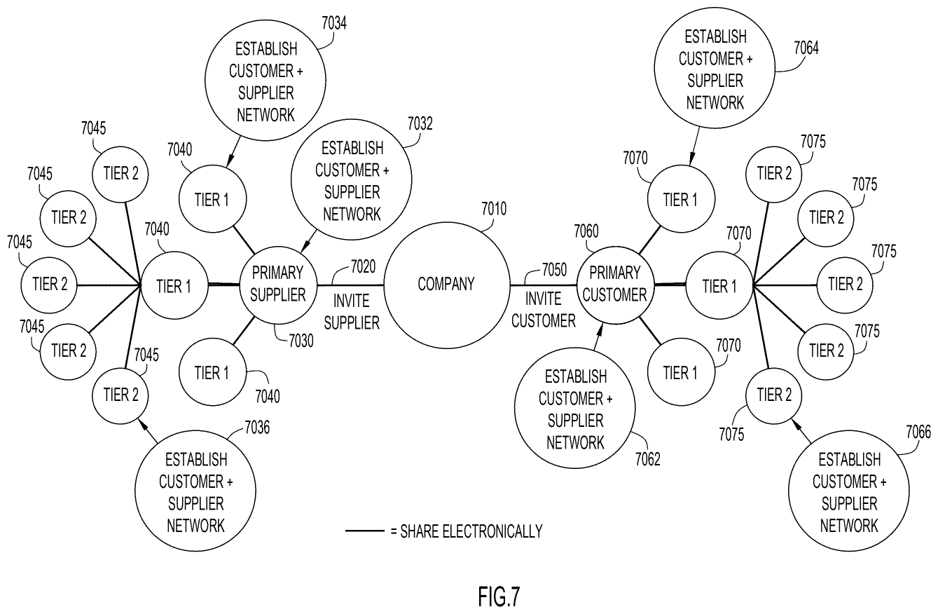

The electronic life cycle assessment system provides the ability to request a supplier to either provide emissions footprint data or perform an entire life cycle assessment (LCA) or to share LCA information electronically with a customer. Referring to FIG. 7, within the electronic life cycle assessment system of an embodiment of the present invention, a company 7010 can request a supplier via a template to complete an LCA, to add inventory data to an LCA in progress, or provide emissions footprint data at flow 7020.

The supplier can electronically complete an LCA in response to a request from their customer for electronic life cycle assessment for their product. This includes sharing with their customer a life cycle assessment that had already been completed in the electronic LCA system at flow 7030.

The electronic LCA system provides the ability for a supplier to, in turn, establish a supplier network of their own for inputs to their products where they need product carbon footprint or other impact analysis information at flow 7032.

A supplier establishes their suppliers in the life cycle assessment system, thereby extending the network of companies that can provide Life Cycle Assessment information to both customers and suppliers across the entire network at flows 7034, 7040.

A supplier of a supplier (tier 2), within the electronic life cycle assessment system, can establish a network of their own at flows 7036, 7045. This can be repeated for as many levels of the supplier network as needed. In addition, a tier 2 supplier can share an electronic LCA with their customers.

A company can invite their customers to view complete or partial electronic life cycle assessments at flow 7050. A customer of one company becomes a primary customer of that company at flow 7060. This same customer can invite other suppliers to the life cycle assessment network, thereby, requesting LCA and emissions footprint from those suppliers at flow 7062.

A customer can, in turn, invite their customers to the electronic life cycle assessment system at flow 7070, thereby becoming a tier 1 customer to that customer. Any tier 1 customer can invite suppliers to the network and ask them to perform a life cycle assessment at flow 7064. A customer of a customer can, in turn, be invited to the network (tier 2) at flow 7075. A tier 2 can in turn invite all its suppliers to the electronic life cycle assessment solution at flow 7066. This can continue for as many tiers as necessary to establish the footprint and environmental impact of a product.

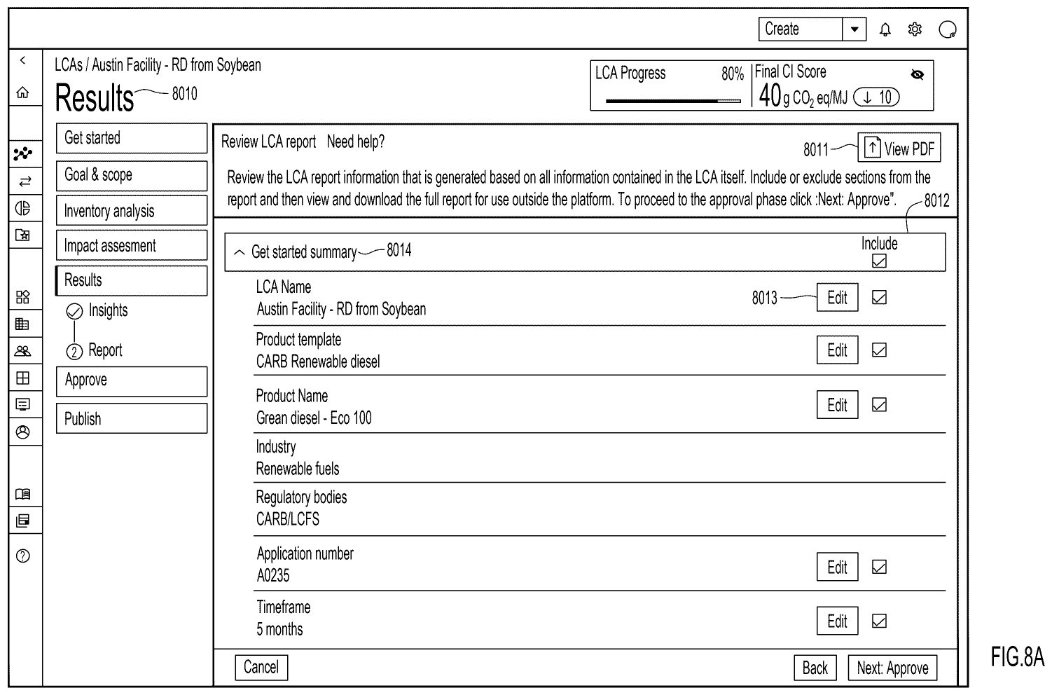

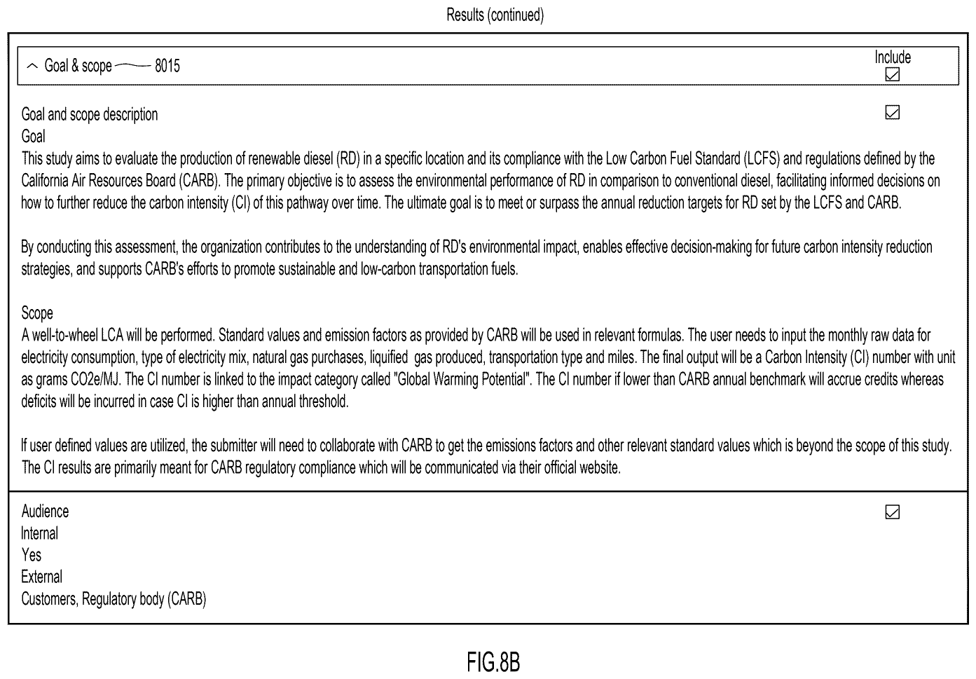

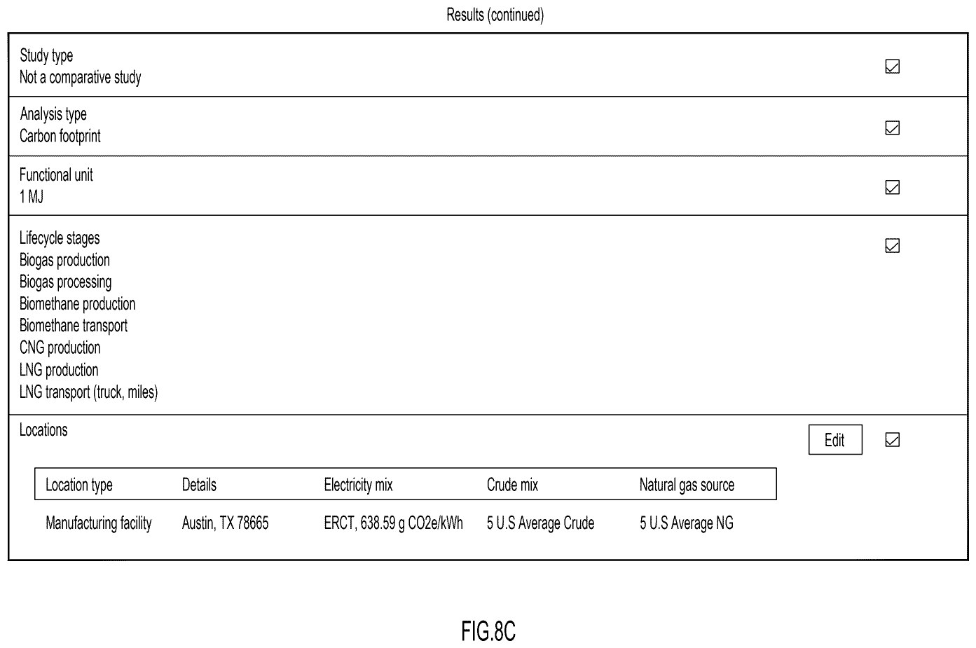

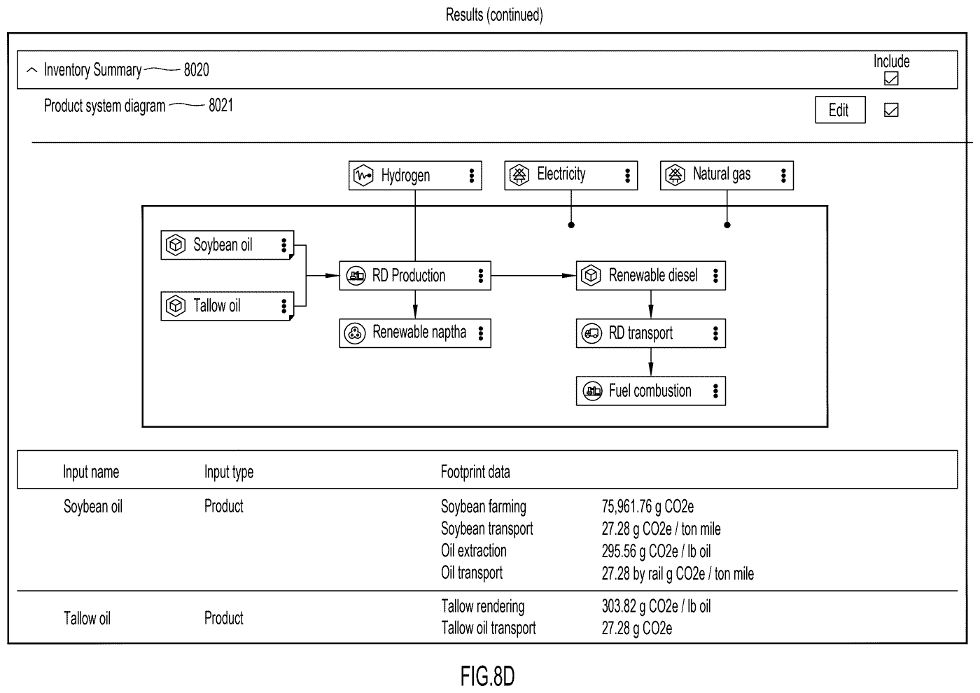

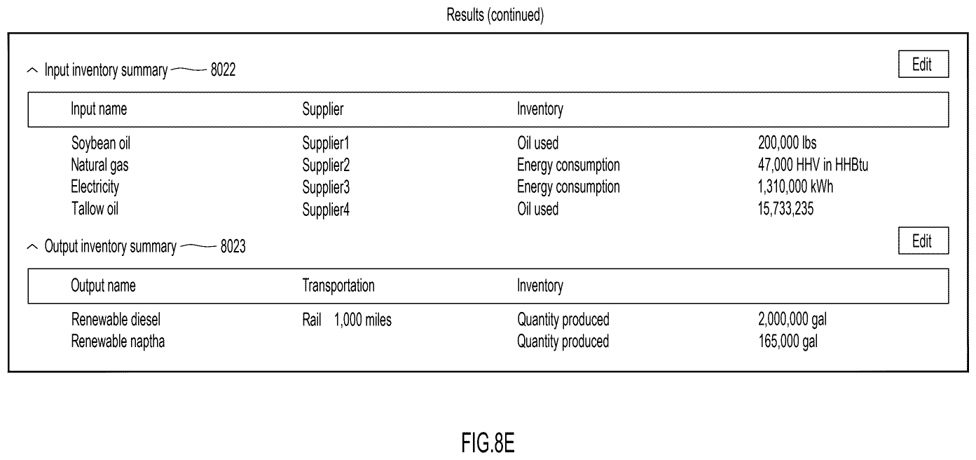

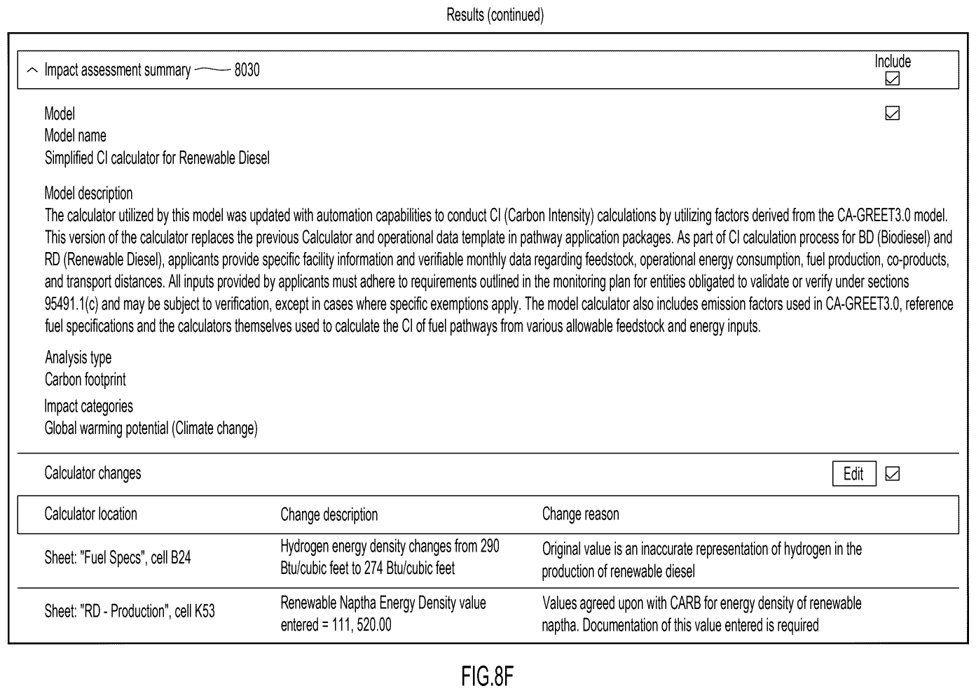

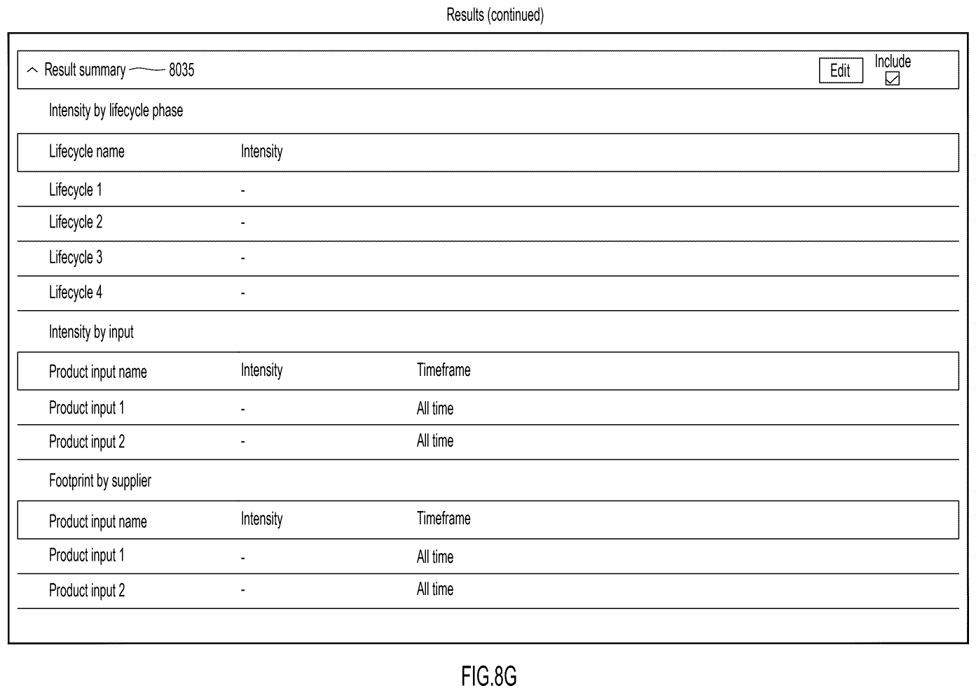

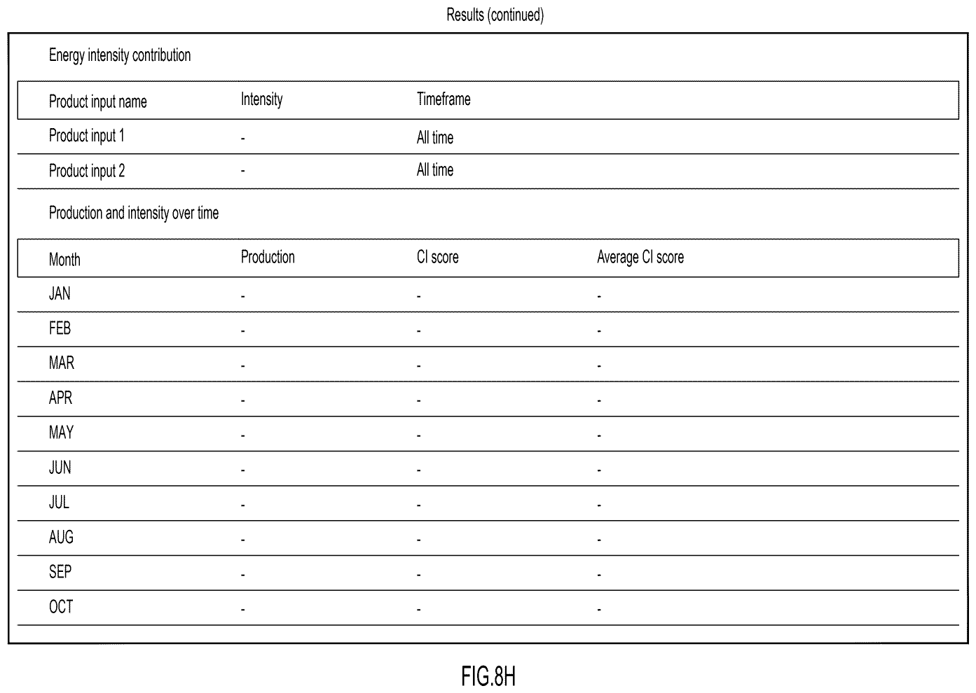

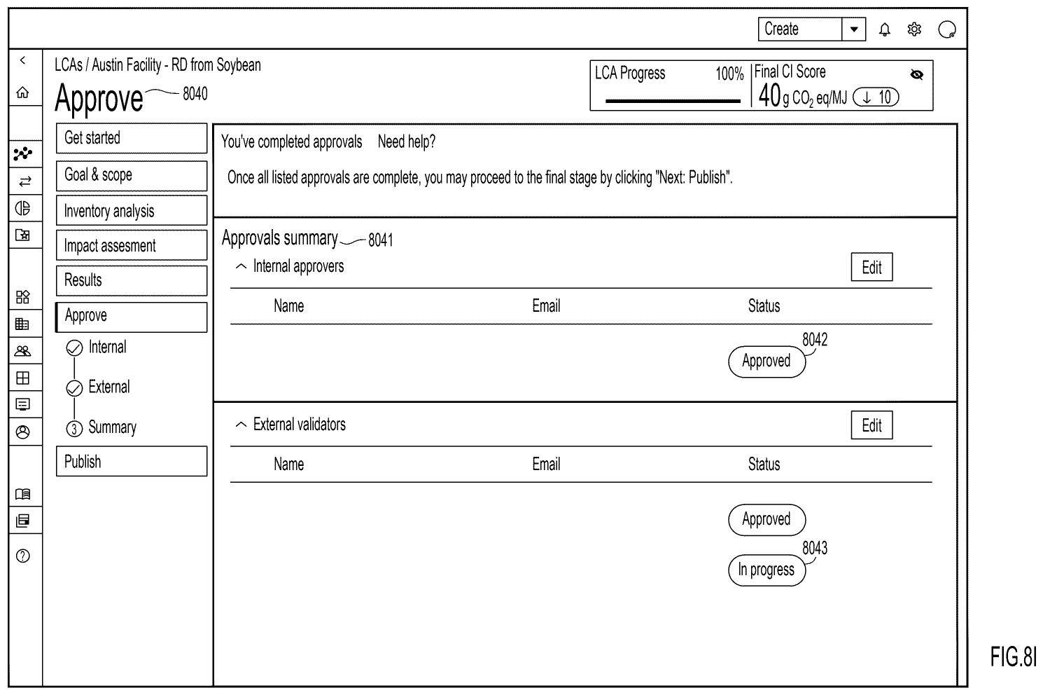

An example Life Cycle Assessment (LCA) (or LCA report) produced by the electronic system according to an embodiment of the present invention is illustrated in FIGS. 8A-8I. By way of example, the electronic system produces a Life Cycle Assessment (LCA) results summary report that the user can view online via a user interface 8010 (FIG. 8A) or download as a PDF or other formats, such as a spreadsheet, at operation 8011. The LCA results summary report is configurable in that the user can decide which sections to include or not include at operation 8012 or they can edit the data in each section of the report prior to it being produced at operation 8013.

The results summary report comprises sections, including but not limited to, Getting Started Summary section 8014 (FIG. 8A), Goal and Scope section 8015 (FIGS. 8B-8C), Inventory Summary section 8020 (FIGS. 8D-8E), Impact Assessment Summary section 8030 (FIG. 8F), Results Summary section 8035 (FIGS. 8G-8H), and Approvals section 8040 (FIG. 8I).

In the results summary report, Getting Started Summary section 8014 (FIG. 8A) includes the LCA name, which system template was used, the product name for which the LCA was completed, the industry producing the product, regulatory bodies, application number, timeframe, and custom fields (e.g., user defined, etc.).

In the results summary report, Goal and Scope section 8015 (FIGS. 8B-8C) includes a goal and scope description or definition, the scope of the LCA, the audience for which it is written (internal or external), the type of study (e.g., either a single product or a comparative study where two alternative products, inputs, or energy sources are compared), the analysis type (e.g., carbon footprint (as defined in (IA-1) of FIG. 2B), etc.), the functional unit, the lifecycle stages that apply (e.g., raw material, process material, manufacture product, transportation, consume product, end of life, recycle, etc.) and the location(s) where the product is produced.

In the results summary report, Inventory Summary section 8020 (FIGS. 8D-8E) includes the system boundary diagram 8021 (which was defined in an LCA template or when creating an LCA), a summary of the input 8022, and a summary of the output and energy footprint data 8023 when carbon footprinting is utilized.

In the results summary report, Impact Assessment Summary section 8030 (FIG. 8F) includes the model's name as provided by the electronic system or a custom model (e.g., built by a model builder), model description, analysis type, impact categories, and a change log of any changes that have been made to the model.

In the results summary report, Results Summary section 8035 (FIGS. 8G-8H) includes the carbon intensity provided by lifecycle stage, by input, by supplier, by energy input, and over time as defined by the time interval defined in the LCA (e.g., daily, weekly, monthly).

In the results summary report, Approvals section 8040 (FIG. 8I) includes a summary of the approvals that occurred on the LCA. Approvals may be internal or external, including third party verifiers who are licensed by a government or other entity to verify the completeness of an LCA. Within the workflow of an LCA, a summary 8041 of the status of the approvals for internal and external approvers is provided. The status may be, but is not limited to, Approved 8042, In Progress 8043, and Rejected.

The LCA system updates Life Cycle Assessments (LCAs) in real-time as data is updated, allowing for all participants in the supply chain to immediately benefit from improvements made to product processes, energy, or inputs. For example, sensors may be coupled to various devices or machines in the supply chain (e.g., manufacturing devices, inventory systems, transportation devices or systems, etc.) to obtain various measurements (e.g., inputs, outputs, environment, metrics, etc.). These measurements may be used by the models to determine the LCA and/or the various impacts. The LCA may be automatically updated in response to new sensor data or trends in the sensor data that affect the LCA or various impacts (e.g., carbon or other footprint, etc.). In addition, the electronic system may generate and send controls for the various devices or machines in the supply chain (e.g., manufacturing devices, inventory systems, transportation devices or systems, computer systems, etc.) to control their operation (or re-configure the supply chain) to reduce the impact (e.g., carbon or other footprint, etc.). By way of example, the controls may control power to the devices or machines (e.g., intermittent or scheduled power-offs, etc.), the operating speed of the devices or machines (e.g., to reduce carbon or other output, etc.), the throughput of the devices or machines, and/or any other aspect that may affect an impact.

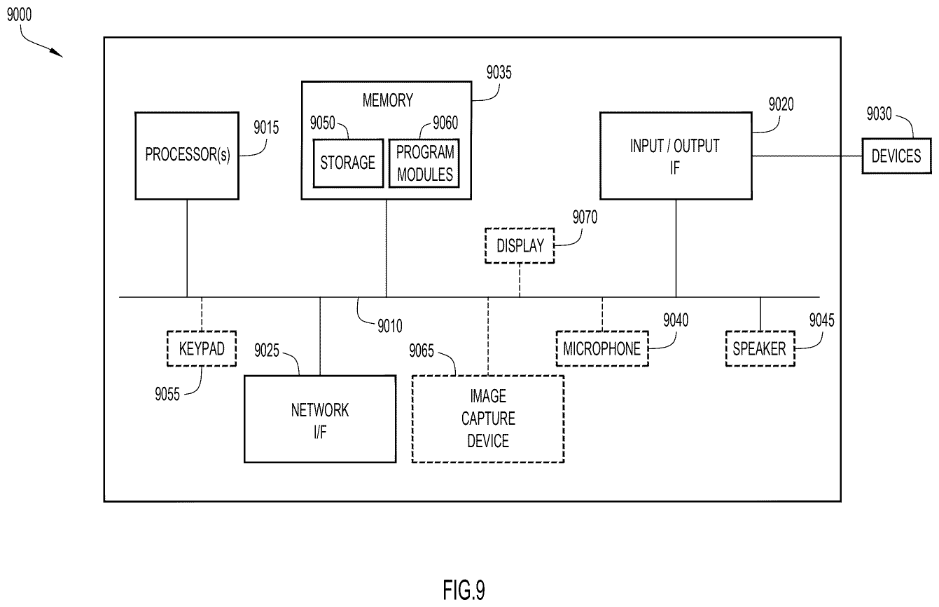

An example of a computing device 9000 (e.g., implementing server systems, client systems, etc.) is illustrated in FIG. 9. The example computing device may perform the functions of present invention embodiments described herein. Computing device 9000 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 9000 may include one or more processors 9015 (e.g., microprocessor, controller, central processing unit (CPU), etc.), network interface 9025, memory 9035, a bus 9010, and an Input/Output interface 9020. Bus 9010 couples these components for communication, and may be of any type of bus structure, including a memory bus or memory controller, a peripheral bus, and a processor or local bus using any of a variety of conventional or other bus architectures. Memory 9035 is coupled to bus 9010 and typically includes computer readable media including volatile media (e.g., random access memory (RAM), cache memory, etc.), non-volatile media, removable media, and/or non-removable media. For example, memory 9035 may include storage 9050 containing nonremovable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 9010 via one or more data interfaces.

Moreover, memory 9035 includes a set of program modules 9060 that are configured to perform functions of present invention embodiments described herein. For example, program modules 9060 may correspond to the system architecture software described above for FIG. 1. The memory may further include an operating system, at least one application and/or other modules, and corresponding data. These may provide an implementation of a networking environment.

Input/Output interface 9020 is coupled to bus 9010 and communicates with one or more peripheral or external devices 9030 (e.g., a keyboard, mouse or other pointing device, a display, sensing devices, etc.), at least one device that enables a user to interact with computing device 9000, and/or any device (e.g., network card, modem, etc.) that enables computing device 9000 to communicate with one or more other computing devices. Computing device 9000 may communicate with one or more networks (e.g., a local area network (LAN), a wide area network (WAN), a public network (e.g., the Internet), etc.) via network interface 9025 coupled to bus 9010.

With respect to certain entities (e.g., client system, etc.), computing device 9000 may further include, or be coupled to, a touch screen or other display 9070, a camera or other image capture device 9065, a microphone or other sound sensing device 9040, a speaker 9045 to convey sound, and/or a keypad or keyboard 9055 to enter information (e.g., alphanumeric information, etc.). These items may be coupled to bus 9010 or Input/Output interface 9020 to transfer data with other elements of computing device 9000.

It will be appreciated that the embodiments described above and illustrated in the drawings represent only a few of the many ways of implementing embodiments for a method and system for electronic life cycle assessment for supply chain management leveraging templates. In addition, characteristics or features of embodiments of the present invention may be combined in any fashion to provide additional embodiments of the present invention.

The computing environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments; etc.). These systems may include any types of monitors and input devices (e.g., keyboard, mouse, voice recognition, etc.) to enter and/or view information.

It is to be understood that the software of the present invention embodiments (e.g., program modules 9060, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., program modules 9060, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer useable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., life cycle assessment templates, models, configurations, data, reports, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

Having described preferred embodiments of a new and improved system, method, and computer program product for electronic life cycle assessment (LCA) for supply chain management leveraging templates, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of configuring and conducting a life cycle assessment comprising:
constructing, via at least one processor, a template for conducting an assessment of an item during a life cycle, wherein the item includes one of a product, process, and service and the template specifies a workflow, one or more models, and factors for conducting the assessment;
performing, via the at least one processor, the assessment in accordance with the template; and
determining, via the at least one processor, a carbon intensity of the item during the life cycle based on the assessment.

2. The method of claim 1, wherein constructing the template comprises:
configuring the template specifically for the item to perform the assessment, wherein the template is configurable with respect to the workflow, inputs, outputs, processes, elements, energy, and emissions factors for the assessment.

3. The method of claim 1, further comprising:
searching, via the at least one processor, an electronic library for emissions factors for the assessment, wherein the electronic library is searchable and indexed using an elastic search.

4. The method of claim 1, further comprising:
generating, via the at least one processor, a custom model to calculate for the assessment a carbon footprint of the item and impacts of the item including one or more from a group of human impacts, ecological impacts, and land use impacts.

5. The method of claim 1, further comprising:
requesting, via the at least one processor, a supplier to perform a corresponding assessment using an associated template, wherein the corresponding assessment satisfies criteria of a requester of the corresponding assessment.

6. The method of claim 1, further comprising:
requesting, via the at least one processor, data from a supplier to complete a portion of the template for the assessment.

7. The method of claim 1, further comprising:
dynamically generating on a user interface, via the at least one processor, a system boundary diagram for the assessment indicating a footprint for the item, wherein the user interface includes configurable inputs, outputs, elements, and energy for the system boundary diagram.

8. The method of claim 1, further comprising:
dynamically displaying on a user interface, via the at least one processor, the carbon intensity for the item based on data being entered into the template.

9. A system for configuring and conducting a life cycle assessment comprising:
one or more memories; and
at least one processor coupled to the one or more memories, and configured to:
construct a template for conducting an assessment of an item during a life cycle, wherein the item includes one of a product, process, and service and the template specifies a workflow, one or more models, and factors for conducting the assessment;
perform the assessment in accordance with the template; and
determine a carbon intensity of the item during the life cycle based on the assessment.

10. The system of claim 9, wherein constructing the template comprises:
configuring the template specifically for the item to perform the assessment, wherein the template is configurable with respect to the workflow, inputs, outputs, processes, elements, energy, and emissions factors for the assessment.

11. The system of claim 9, wherein the at least one processor is further configured to:
generate a custom model to calculate for the assessment a carbon footprint of the item and impacts of the item including one or more from a group of human impacts, ecological impacts, and land use impacts.

12. The system of claim 9, wherein the at least one processor is further configured to:
request data from a supplier to complete a portion of the template for the assessment.

13. The system of claim 9, wherein the at least one processor is further configured to:
dynamically generate on a user interface a system boundary diagram for the assessment indicating a footprint for the item, wherein the user interface includes configurable inputs, outputs, elements, and energy for the system boundary diagram.

14. The system of claim 9, wherein the at least one processor is further configured to:
dynamically display on a user interface the carbon intensity for the item based on data being entered into the template.

15. A computer program product for configuring and conducting a life cycle assessment comprising one or more computer readable media having instructions stored thereon, the instructions executable by at least one processor to cause the at least one processor to:
construct a template for conducting an assessment of an item during a life cycle, wherein the item includes one of a product, process, and service and the template specifies a workflow, one or more models, and factors for conducting the assessment;
perform the assessment in accordance with the template; and
determine a carbon intensity of the item during the life cycle based on the assessment.

16. The computer program product of claim 15, wherein constructing the template comprises:
configuring the template specifically for the item to perform the assessment, wherein the template is configurable with respect to the workflow, inputs, outputs, processes, elements, energy, and emissions factors for the assessment.

17. The computer program product of claim 15, wherein the instructions further cause the at least one processor to:
generate a custom model to calculate for the assessment a carbon footprint of the item and impacts of the item including one or more from a group of human impacts, ecological impacts, and land use impacts.

18. The computer program product of claim 15, wherein the instructions further cause the at least one processor to:
request data from a supplier to complete a portion of the template for the assessment.

19. The computer program product of claim 15, wherein the instructions further cause the at least one processor to:
dynamically generate on a user interface a system boundary diagram for the assessment indicating a footprint for the item, wherein the user interface includes configurable inputs, outputs, elements, and energy for the system boundary diagram.

20. The computer program product of claim 15, wherein the instructions further cause the at least one processor to:
dynamically display on a user interface the carbon intensity for the item based on data being entered into the template.
